(19) United States
(12) Patent Application Publication
(10) Pub. No.: US 2014/0069595 A1
(43) Pub. Date: Mar. 13, 2014

(54) AUTOMATIC ROLLER SHADE

(71) Applicant: JU-HUAI CHEN, Ershui Township (TW)

(72) Inventor: JU-HUAI CHEN, Ershui Township (TW)

(73) Assignee: CHICOLOGY, INC., Ontario, CA (US)

(21) Appl. No.: 13/615,295

(22) Filed: Sep. 13, 2012

(51) Int. Cl. E06B 9/68; E06B 9/72

(52) U.S. Cl. 160/291

(57) ABSTRACT

An automatic roller shade includes a shade body rotatably mounted to between a first and a second mounting bracket; a stop mechanism mounted in an end of a roller of the shade body; and a driving mechanism mounted in another opposite end of the roller. The stop mechanism includes a winding element connected to the roller and a spiral spring element having an end connected to the winding element. The spiral spring element enables a balance between a force for lifting or winding a shade fabric of the shade and the gravitational force lowering or unwinding the shade fabric. The driving mechanism at the other end of the roller can adopt a micro motor as a power source and the micro motor can be invisibly located inside the roller, enabling the automatic roller shade to have reduced power consumption and manufacturing cost while having a compact and esthetic appearance.

### FIELD OF THE INVENTION

The present invention relates to a roller shade, and more particularly to an automatic roller shade, of which a shade fabric can be automatically wound and lifted or unwound and lowered.

### BACKGROUND OF THE INVENTION

Many conventional window shades, such as the Roman shades, have a shade fabric that can be vertically lifted or lowered. These vertically operable window shades usually include a head rail, a lifting unit and a shade fabric connected to and hung from the head rail. The head rail is mounted to an upper edge of a window; the lifting unit includes a plurality of pull cords and lifting cords; and the shade fabric has an upper edge connected to the head rail and a lower edge controlled by the lifting unit to vertically move upward or downward. The pull cords and lifting cords are usually located at lateral sides of the window shade and can be easily accessed by a small child playing near the window shade. The small child playing near the window shade is subject to the danger of being unexpectedly strangulated by the cords. Therefore, the exposed pull cords and lifting cords of the window shades form a big potential threat to the safety of small children. In addition, the cords of the lifting unit are also subject to tangling with one another to cause inconveniences in use.

To solve the above problems in the conventional window shades, many types of cordless automatic roller shades, i.e. power-operated roller shades, have been developed and introduced into market. The currently available automatic roller shades mainly include a driving motor mounted to an end of a head roller to provide the power needed to operate the roller shades. When a user pushes a button on a corresponding remote controller, the driving motor is started and drives the head roller to rotate about its axis, so that the shade fabric is wound around the roller and lifted or is unwound from the roller and lowered. The conventional roller shades also include a lower bar, which is connected to a lower edge of the shade fabric and has a certain weight. Therefore, the conventional roller shades usually require a large-scale servo motor to serve as the driving motor to provide relatively large power for winding and accordingly lifting the shade fabric. The large-scale servo motor inevitably increases the manufacturing cost of the roller shade. Further, the large-scale servo motor could not be invisibly mounted inside the head roller and is usually externally mounted to an end of the head roller, giving the whole roller shade a bulky and unpleasant appearance.

It is therefore tried by the inventor to develop an improved automatic roller shade that overcomes the drawbacks in the conventional automatic roll shades to achieve the advantages of reduced power consumption and manufacturing cost as well as compact and esthetic appearance.

### SUMMARY OF THE INVENTION

A primary object of the present invention is to provide an automatic roller shade that has reduced power consumption and manufacturing cost while having a compact and esthetic appearance.

To achieve the above and other objects, the automatic roller shade according to the present invention has a structural design combining a first mounting bracket, a second mounting bracket, a shade body, a stop mechanism and a driving mechanism to overcome the problem of requiring a large-sized motor as found in the conventional automatic roller shades, and can therefore have the advantages of reduced power consumption, lowered manufacturing cost, and compact and esthetic appearance.

The automatic roller shade according to a preferred embodiment of the present invention includes a first mounting bracket having a first supporting section and a second supporting section located adjacent to and spaced from the first supporting section; a second mounting bracket corresponding to the first mounting bracket; a stop mechanism including a spiral spring element mounted to the first supporting section of the first mounting bracket and a winding element rotatably mounted to the second supporting section of the first mounting bracket, and the spiral spring element having an end connected to the winding element; a driving mechanism including a micro motor and a transmission element connected to the micro motor, and the micro motor having an end coupled to the second mounting bracket; and a shade body including a roller and a shade fabric connected to the roller, the roller having an end connected to the winding element of the stop mechanism and another opposite end connected to the transmission element of the driving mechanism, and the micro motor being completely located inside the roller.

In the automatic roller shade according to the preferred embodiment of the present invention, the first supporting section has a first shaft connected thereto, and the second supporting section has a second shaft connected thereto; the spiral spring element is fitted around the first shaft, and the winding element is rotatably fitted around the second shaft.

In the automatic roller shade according to the preferred embodiment of the present invention, the stop mechanism further includes two stoppers clamped to two opposite lateral sides of the spiral spring element.

In the automatic roller shade according to the preferred embodiment of the present invention, the winding element includes a spindle and a reel; the spindle is rotatably mounted on the second supporting section; the reel is connected to the spindle; and the end of the spiral spring element connected to the winding element is connected to the reel of the winding element.

In the automatic roller shade according to the preferred embodiment of the present invention, the stop mechanism further includes a coupled axle; the coupled axle has an end connected to the winding element and another opposite end connected to the end of the roller that is connected to the winding element.

In the automatic roller shade according to the preferred embodiment of the present invention, the stop mechanism further includes a case connected to the first mounting bracket to cover the spiral spring element and the winding element in between the cover and the first mounting bracket.

In the automatic roller shade according to the preferred embodiment of the present invention, the driving mechanism further includes a housing connected to the second mounting bracket; the micro motor is mounted in the housing, and the housing with the micro motor mounted therein is then fitted in the roller.

In the automatic roller shade of the present invention, the spiral spring element of the stop mechanism is connected to the winding element and accordingly to the roller of the shade body to unwind or rewind when the winding element and the roller rotate, and a nominal elastic rewinding force of the spiral spring element can be used to balance the force for lifting or rewinding the shade fabric and the gravitational force lowering or unwinding the shade fabric, so that the lifting of the shade fabric does not require a relatively large upward winding force and the shade fabric can stay at the selected height after it has been lifted or lowered. With the spiral spring element, the micro motor can be adopted as a power source of the driving mechanism to reduce the power consumption and manufacturing cost of the automatic roller shade. Further, the micro motor can be invisibly located in the roller of the shade body, allowing the whole roller shade to have a compact and esthetic appearance.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of an automatic roller shade according to a preferred embodiment of the present invention;

FIG. 2 is an exploded view of FIG. 1;

FIG. 3 is a sectional view of a stop mechanism for the automatic roller shade of the present invention;

FIG. 4 is an assembled perspective view of a driving mechanism for the automatic roller shade of the present invention;

FIG. 5 is an exploded view of FIG. 4; and

FIG. 6 shows the automatic roller shade of the present invention in use.

### DETAILED DESCRIPTION OF THE PREFERRED EMBODIMENTS

The present invention will now be described with a preferred embodiment thereof and with reference to the accompanying drawings.

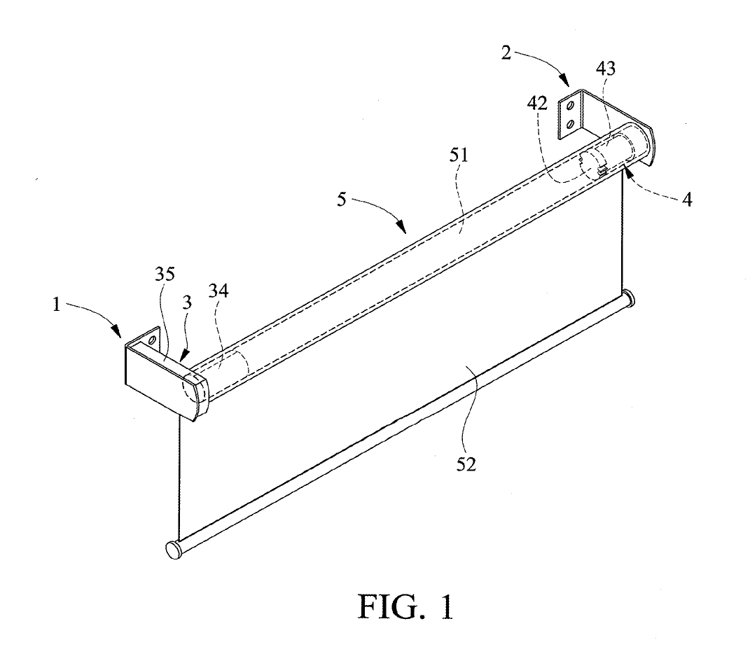

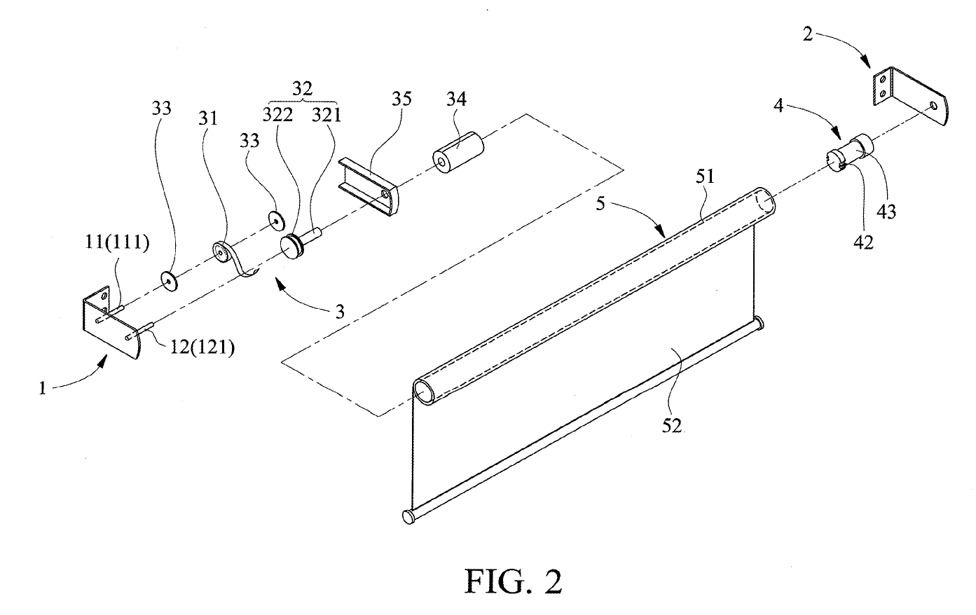

Please refer to FIGS. 1 and 2 that are assembled and exploded perspective views, respectively, of an automatic roller shade according to a preferred embodiment of the present invention. As shown, the automatic roller shade in the illustrated preferred embodiment includes a first mounting bracket 1, a second mounting bracket 2, a stop mechanism 3, a driving mechanism 4, and a shade body 5.

As can be seen in FIG. 2, the first mounting bracket 1 is a member to be fixedly mounted on a wall and is provided with a first supporting section 11 and a second supporting section 12 located adjacent to and spaced from the first supporting section 11. The first supporting section 11 has a first shaft 111 connected thereto, and the second supporting section 12 has a second shaft 121 connected thereto.

As also can be seen in FIG. 2, the second mounting bracket 2 is a member corresponding to the first mounting bracket 1 and is also to be fixedly mounted on a wall, so that the shade body 5 can be rotatably supported on between the first and the second mounting bracket 1, 2.

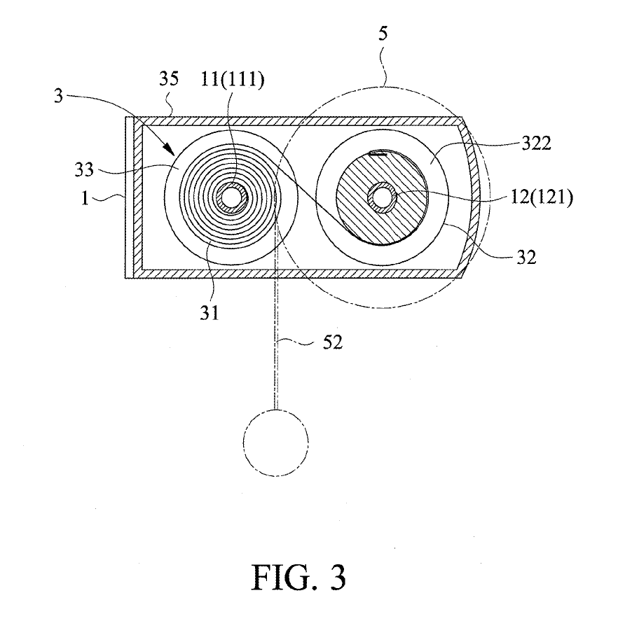

Please refer to FIG. 3 along with FIG. 2. The stop mechanism 3 includes a spiral spring element 31 mounted to the first supporting section 11 of the first mounting bracket 1, and a winding element 32 rotatably mounted to the second supporting section 12 of the first mounting bracket 1. The spiral spring element 31 is fitted around the first shaft 111 connected to the first supporting section 11, and has one end connected to the winding element 32. The winding element 32 is rotatably fitted around the second shaft 121 connected to the second supporting section 12 for winding the spiral spring element 31 therearound or releasing the spiral spring element 31 therefrom.

Please refer to FIGS. 2, 4 and 5 at the same time. The driving mechanism 4 includes a micro motor 41 and a transmission element 42 connected to a rotary shaft of the micro motor 41. The micro motor 41 can be a micro DC motor or a micro AC motor, and has an end opposite to the rotary shaft being directly or indirectly connected to the second mounting bracket 2. The transmission element 42 is used to bring the shade body 5 to move.

As can be seen in FIGS. 1 and 2, the shade body 5 includes a roller 51 and a shade fabric 52. The roller 51 is a hollow tube, an end of which is connected to the winding element 32 of the stop mechanism 3 for the roller 51 to move along with the winding element 32; and another opposite end of which is connected to the transmission element 42 of the driving mechanism 4 while the micro motor 41 is received in the hollow roller 51. The shade fabric 52 has an upper edge connected to the roller 51 and can be wound around the roller 51 to a lifted position or be released from the roller 51 to a lowered position.

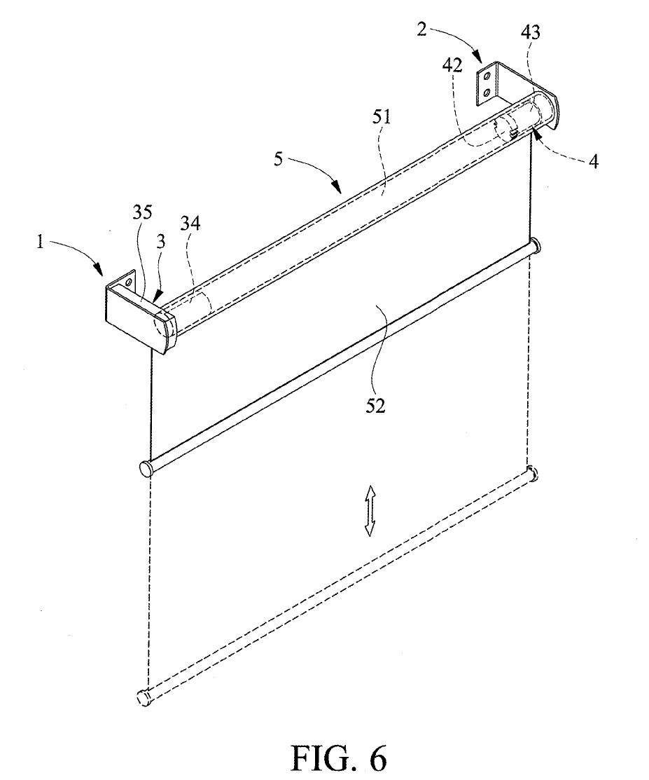

With the automatic roller shade assembled from the above-described first mounting bracket 1, second mounting bracket 2, stop mechanism 3, driving mechanism 4 and shade body 5, the roller 51 of the shade body 5 can be automatically rotated by the driving mechanism 4 to wind the shade fabric 52 therearound or release the shade fabric 52 therefrom, so that the shade fabric 52 can be lifted or lowered to any desired position without the need of manually operating any pull cord, as shown in FIG. 6.

As shown in FIG. 2, the winding element 32 according to a preferred embodiment thereof includes a spindle 321 and a reel 322. The spindle 321 is rotatably mounted on the second shaft 121 at the second supporting section 12 of the first mounting bracket 1; and the reel 322 is integrally formed at or assembled to one end of the spindle 321. With an end of the spiral spring element 31 connected the reel 322, the reel 322 can be used to wind the spiral spring element 31 therearound or release the same therefrom to achieve the function of controlling the shade body 5.

As shown in FIG. 2, the stop mechanism 3 according to a preferred embodiment thereof further includes two stoppers 33 clamped to two opposite lateral sides of the spiral spring element 31 to ensure smooth unwinding and rewinding of the spiral spring element 31. The stop mechanism 3 according to the preferred embodiment thereof further includes a coupled axle 34. The coupled axle 34 has an end connected to the spindle 321 of the winding element 32 and another opposite end connected to one end of the roller 51 of the shade body 5, so that the roller 51 can be brought by the coupled axle 34 and the winding element 32 to rotate for the purpose of controlling the shade fabric 52 to a desired height. Moreover, the stop mechanism 3 according to the preferred embodiment thereof further includes a case 35 connected to the first mounting bracket 1 for covering the spiral spring element 31 and the winding element 32 in between the case 35 and the first mounting bracket 1.

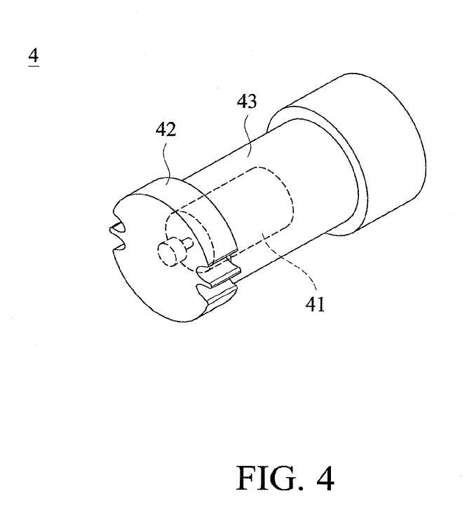

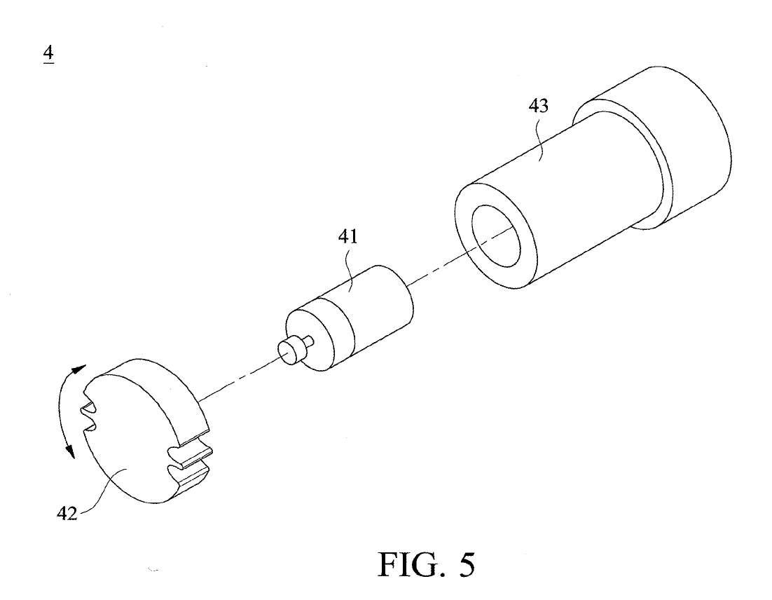

Please refer to FIGS. 4 and 5 again. The driving mechanism 4 according to a preferred embodiment thereof includes a housing 43 connected to the second mounting bracket 2. The housing 43 is a hollow cylindrical member being sized corresponding to an inner diameter of the roller 51. The micro motor 41 is mounted in the housing 43, and the housing 43 with the micro motor 41 mounted therein is then fitted in the roller 51, so that the driving mechanism 4 is invisibly from an outer side of the roller shade.

Please refer to FIG. 6. To use the automatic roller shade according to the present invention, simply actuate the micro motor 41 of the driving mechanism 4 to drive the transmission element 42 and the roller 51 to rotate, so that the shade fabric 52 is wound around or released from the roller 51 to a lifted or a lowered position. Please also refer to FIG. 3. When the roller 51 is rotated to lower the shade fabric 52, the winding element 32 of the stop mechanism 3 is synchronously brought by the roller 51 to wind the spiral spring element 31 around the winding element 32. When the micro motor 41 is stopped, a balance between the weight of the shade fabric 52 and the spring force of the spiral spring element 31 enables the shade fabric 52 to stay at the lowered position. On the other hand, when the driving mechanism 4 drives the roller 51 to rotate reversely, the spiral spring element 31 is released from the winding element 32 and rewound, so that the shade fabric 52 is rewound around the roller 51 and lifted to a higher position.

The present invention is characterized in that, by providing the stop mechanism 3 and the driving mechanism 4 to two opposite ends of the shade body 5, an elastic rewinding force of the spiral spring element 31 can be used to balance the forces for lifting (i.e. rewinding) the shade fabric 52 and the gravitational force lowering (i.e. unwinding) the shade fabric 52. That is, with the present invention, the lifting of the shade fabric 52 does not require a relatively large upward winding force. Therefore, the micro motor 41 can be adopted as a power source of the driving mechanism 4. For instance, in the case of a shade body 5 of 10 kg in weight, a micro motor 41 having a torque of 6 kg is sufficient to rotate the roller 51 and lift or lower the shade fabric 52. By using the micro motor 41, power consumption and manufacturing cost of the automatic roller shade can be largely reduced. Further, in the present invention, since the micro motor 41 can be invisibly located in the roller 51 of the shade body 5, the whole roller shade has a compact and esthetic appearance.

With the above arrangements, the present invention is novel, improved and industrially valuable for use. The present invention is novel and improved because it overcomes the problem of requiring a large-sized motor as found in the conventional automatic roller shades to thereby achieve the advantages of saving electric power, reducing manufacturing cost and showing a compact and esthetic appearance. The present invention is industrially valuable for use because its structural characteristics and technical measures would doubtlessly meet the demands in the current market.

The present invention has been described with a preferred embodiment thereof and it is understood that many changes and modifications in the described embodiment can be carried out without departing from the scope and the spirit of the invention that is intended to be limited only by the appended claims.

What is claimed is:

1. An automatic roller shade, comprising:
a first mounting bracket having a first supporting section and a second supporting section located adjacent to and spaced from the first supporting section;
a second mounting bracket corresponding to the first mounting bracket;
a stop mechanism including a spiral spring element mounted to the first supporting section of the first mounting bracket and a winding element rotatably mounted to the second supporting section of the first mounting bracket; and the spiral spring element having an end connected to the winding element;
a driving mechanism including a micro motor and a transmission element connected to the micro motor; and the micro motor having an end coupled to the second mounting bracket; and
a shade body including a roller and a shade fabric connected to the roller;
the roller having an end connected to the winding element of the stop mechanism and another opposite end connected to the transmission element of the driving mechanism; and the micro motor being completely located inside the roller.

2. The automatic roller shade as claimed in claim 1, wherein the first supporting section has a first shaft connected thereto, and the second supporting section has a second shaft connected thereto; the spiral spring element being fitted around the first shaft, and the winding element being rotatably fitted around the second shaft.

3. The automatic roller shade as claimed in claim 1, wherein the stop mechanism further includes two stoppers clamped to two opposite lateral sides of the spiral spring element.

4. The automatic roller shade as claimed in claim 1, wherein the winding element includes a spindle and a reel; the spindle being rotatably mounted on the second supporting section; the reel being connected to the spindle; and the end of the spiral spring element connected to the winding element being connected to the reel of the winding element.

5. The automatic roller shade as claimed in claim 1, wherein the stop mechanism further includes a coupled axle; the coupled axle having an end connected to the winding element and another opposite end connected to the end of the roller that is connected to the winding element.

6. The automatic roller shade as claimed in claim 4, wherein the stop mechanism further includes a coupled axle; the coupled axle having an end connected to the winding element and another opposite end connected to the end of the roller that is connected to the winding element.

7. The automatic roller shade as claimed in claim 1, wherein the stop mechanism further includes a case connected to the first mounting bracket to cover the spiral spring element and the winding element in between the cover and the first mounting bracket.

8. The automatic roller shade as claimed in claim 1, wherein the driving mechanism further includes a housing connected to the second mounting bracket; the micro motor being mounted in the housing, and the housing with the micro motor mounted therein being then fitted in the roller.
